(19) United States
(12) Patent Application Publication
(10) Pub. No.: US 2012/0206403 A1
(43) Pub. Date: Aug. 16, 2012

(54) TOUCH-SENSING DISPLAY DEVICE

(75) Inventors: Po-Hsien WANG, Tai Chung City (TW); Cheng-Yen Yeh, Tai Chung County (TW); Chen-Hao Su, Tai Chung County (TW); Yu-Ting Chen, Chia Yi City (TW)

(73) Assignee: Wintek Corporation

(21) Appl. No.: 13/369,832

(22) Filed: Feb. 9, 2012

(30) Foreign Application Priority Data
Feb. 11, 2011 (TW) 10104645

(51) Int. Cl. G06F 3/045

(52) U.S. Cl. 345/174

(57) ABSTRACT

A touch-sensitive display device includes a color filter substrate, an array substrate, a liquid crystal layer, and a touch-sensing structure. The touch-sensing structure is disposed on the color filter substrate and includes at least one first sensing series and at least one second sensing series overlapped with and spaced apart from the first sensing series. During a touch-sensing operation, the first sensing series receives a common voltage scanning signal, and the second sensing series receives a sensing signal to sense coupling capacitance formed as a result of a touch action when the common voltage scanning signal drives the first sensing series.

### BACKGROUND OF THE INVENTION

a. Field of the Invention

The invention relates to a touch-sensitive display device.

b. Description of the Related Art

Nowadays, a common touch-sensitive display device is formed by a display panel and an add-on touch panel or cover glass to result in a considerable thickness, and the light-transmittance is also reduced due to frequent surface reflection. However, such problem can be solved by directly integrating touch-sensing functions into a display device. In case touch-sensing functions are integrated into a liquid crystal display, additional touch-sensing wiring is needed in addition to original display wirings. Therefore, the touch-sensing wiring may occupy part of an active display area to lower the aperture ratio of a liquid crystal display, and mutual interference between touch-sensing signals and display signals as well as the driving loads are also increased.

### BRIEF SUMMARY OF THE INVENTION

The invention provides a touch-sensitive display device having high production yields, low-profile, high aperture ratio and low signal interference.

One embodiment of the invention provides a touch-sensitive display device, including a color filter substrate, an array substrate, a liquid crystal layer and a touch-sensing structure. The array substrate is disposed opposite the color filter substrate and spaced apart from the color filter substrate. The liquid crystal layer is disposed between the color filter substrate and the array substrate. The touch-sensing structure is disposed on the color filter substrate and includes at least one first sensing series and at least one second sensing series overlapped with and spaced apart from the first sensing series. During a touch-sensing operation, the first sensing series receives a common voltage scanning signal and the second sensing series receives a sensing signal to sense coupling capacitance formed as a result of a touch action when the common voltage scanning signal drives the first sensing series.

In one embodiment, the first sensing series is disposed on one side of the color filter substrate facing the array substrate, and the second sensing series is disposed on one side of the color filter substrate back to the array substrate. Alternatively, the first sensing series is disposed on one side of the color filter substrate back to the array substrate, and the second sensing series is disposed on one side of the color filter substrate facing the array substrate.

In one embodiment, the first sensing series includes n (n is a positive integer) first stripe electrodes substantially parallel to each other, and the common electrode scanning signal successively drives the first stripe electrodes. The second sensing series includes a plurality of second stripe electrodes substantially parallel to each other, and the second stripe electrodes cross the first stripe electrodes.

In one embodiment, a plurality of common lines are formed on the array substrate and the first sensing series is connected with the common lines. Conductive media are disposed between the color filter substrate and the array substrate to electrically connect the first sensing series with the common lines. The conductive medium includes, for example, a conductive spacer or silver paste.

In one embodiment, a decorative layer is disposed a periphery of the color filter substrate, and the decorative layer includes at least one of ceramic, diamond-like carbon, color ink, photo resist and resin.

According to the above embodiments, since the sensing series of the touch-sensing structure also serves as a common electrode needed to drive the liquid crystal layer, the driving wiring of the touch-sensing structure and the reference voltage wiring of the display structure are integrated together to reduce signal interference and load, decrease the area of wiring layout to increase the aperture ratio, and reduce the size and weight of the entire device.

Another embodiment of the invention also provides a touch-sensitive display device, including a color filter substrate, an array substrate, a liquid crystal layer, a cover glass and a touch-sensing structure. The array substrate is disposed opposite the color filter substrate and spaced apart from the color filter substrate. The liquid crystal layer is disposed between the color filter substrate and the array substrate. The cover glass is disposed on one side of the color filter substrate back to the array substrate. The touch-sensing structure includes a first sensing series and a second sensing series overlapped with and spaced apart from the first sensing series. During a touch-sensing operation, the first sensing series receives a common voltage scanning signal and the second sensing series receives a sensing signal to sense coupling capacitance formed as a result of a touch action when the common voltage scanning signal drives the first sensing series.

In one embodiment, the first sensing series is formed on the color filter substrate and the second sensing series is formed on the cover glass, or the first sensing series is formed on the cover glass and the second sensing series is formed on the color filter substrate.

In one embodiment, the first sensing series is disposed on one side of the color filter substrate facing the cover glass, and the second sensing series is disposed on one side of the cover glass facing the color filter substrate. Alternatively, the first sensing series is formed on one side of the color filter substrate facing the array substrate and serves as a common electrode needed to drive the liquid crystal layer, and the second sensing series is formed on one side of the cover glass facing the color filter substrate.

According to the above embodiments, a touch-sensitive display device is formed simply by combining a display panel and a cover glass that are respectively subject to a treatment of forming transparent electrodes (such as ITO). Therefore, the number of fabrication processes is reduced and the product yields are improved.

Another embodiment of the invention also provides a touch-sensitive display device, including a first substrate, a second substrate, a liquid crystal layer, a touch-sensing structure and a signal processing unit. The second substrate is disposed opposite the first substrate and is spaced apart from the first substrate. The liquid crystal layer is disposed between the first substrate and the second substrate. The touch-sensing structure is disposed at least on the first substrate and includes a plurality of driving electrodes and a plurality of sensing electrodes overlapped with and spaced apart from the driving electrodes. The signal processing unit is disposed on the second substrate. The signal processing unit outputs at least one gate drive signal, at least one pixel data signal, and at least one common voltage scanning signal to drive the liquid crystal layer and effect image display. The signal processing unit also outputs at least one sensing signal to sense coupling capacitance formed as a result of a touch action, and each of the sensing electrodes receives the sensing signal to sense the coupling capacitance when the common voltage scanning signal successively drives the driving electrodes.

In one embodiment, the gate drive signal is in a low voltage level during the occurrence of pulses of the common voltage scanning signal.

In one embodiment, pulses of the common voltage scanning signal are interpolated and evenly spaced in one display frame.

In one embodiment, the frame time of a display frame is divided into a display period and a touch-sensing period, and the common voltage scanning signal drives the driving electrodes only in the touch-sensing period.

In one embodiment, a cover glass is adhered on one side of the first substrate back to the second substrate, and the touch-sensing structure is disposed on the first substrate and the cover glass.

Other objects and advantages of the invention can be better understood from the technical characteristics disclosed by the invention. In order to have one of the above purposes, all the purposes, or other purposes, features and advantages of the invention be further understood, the embodiments of invention accompanying with figures will be described in details in the following.

### BRIEF DESCRIPTION OF THE DRAWINGS

FIG. 1 shows a schematic plan view of a touch-sensitive display device according to an embodiment of the invention.

FIG. 2 shows a schematic diagram illustrating a structure embodiment of the touch-sensitive display device shown in FIG. 1.

FIG. 3 shows a timing diagram of a display signal and a touch-sensing signal according to an embodiment of the invention.

FIG. 4 shows a timing diagram of a display signal and a touch-sensing signal according to another embodiment of the invention.

FIG. 5A shows a schematic plan view of a touch-sensitive display device according to another embodiment of the invention, and FIG. 5B shows a partial cross-section of FIG. 5A.

FIG. 6A and FIG. 6B show schematic diagrams illustrating different sensing electrode structures according to different embodiments of the invention.

FIG. 7 shows a schematic diagram of a touch-sensitive display device according to another embodiment of the invention.

FIG. 8 shows a schematic diagram of a touch-sensitive display device according to another embodiment of the invention.

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

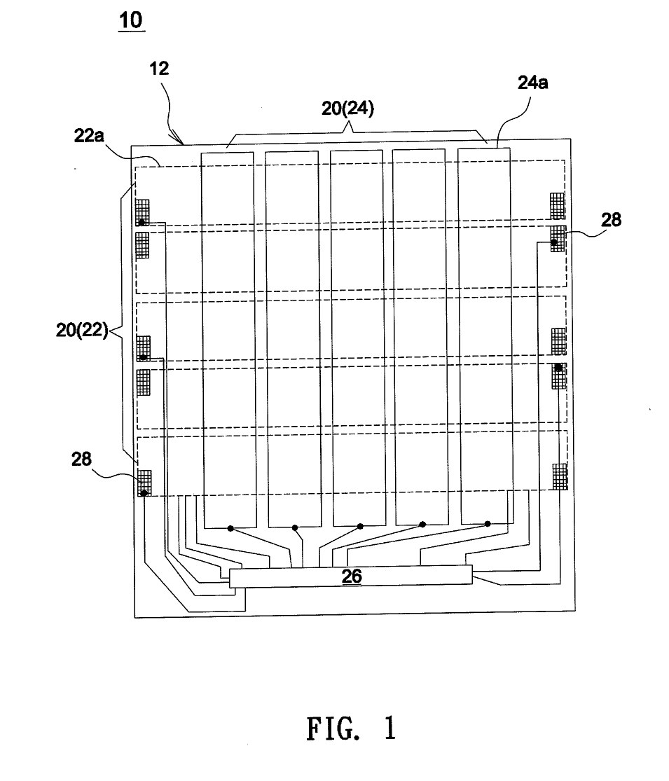

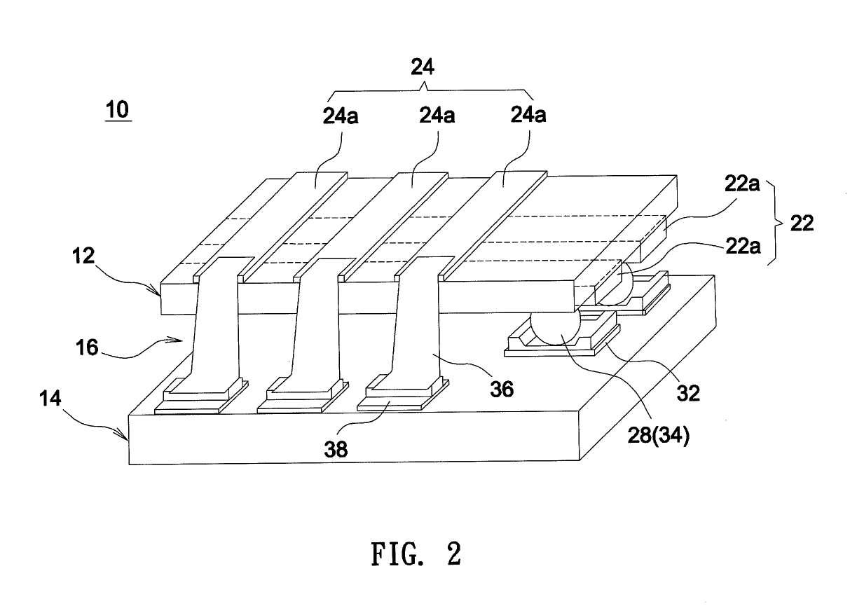

FIG. 1 shows a schematic plan view of a touch-sensitive display device according to an embodiment of the invention. FIG. 2 shows a schematic diagram illustrating a structure embodiment of the touch-sensitive display device shown in FIG. 1. Please refer to both FIG. 1 and FIG. 2, a touch-sensitive display device 10 includes a color filter substrate 12, an array substrate 14, a liquid crystal layer 16 and a touch-sensing structure 20. The array substrate 14 is disposed opposite the color filter substrate 12 and spaced apart from the color filter substrate 12. The liquid crystal layer 16 is disposed between the color filter substrate 12 and the array substrate 14. The touch-sensing structure 20 is formed on the color filter substrate 12 and includes at least one sensing series 22 and at least one sensing series 24. The sensing series 24 is overlapped with the sensing series 22 and spaced apart from the sensing series 22. In this embodiment, the sensing series 22 includes, for example, a plurality of transparent electrodes 22a and is formed on one side of the color filter substrate 12 facing the array substrate 14. The sensing series 24 includes, for example, a plurality of transparent electrodes 24a and is formed on one side of the color filter substrate 12 back to the array substrate 14. The transparent electrodes 22a and the transparent electrodes 24a are disposed crossing to each other. The touch-sensitive display device 10 performs both touch-sensing and image display operations. The sensing series 22 and the sensing series 24 are respectively connected to two different signal sources. In this embodiment, the sensing series 22 serves as a common electrode used to drive the liquid crystal layer 16 during the image display operation. During the touch-sensing operation, the sensing series 22 receives a common voltage scanning signal, and the sensing series 24 receives a sensing signal to sense coupling capacitance formed as a result of a touch action when the common voltage scanning signal drives the sensing series 22. In an alternate embodiment, the sensing series 24 may receive a common voltage scanning signal, and the sensing series 22 may receive a sensing signal for the touch-sensing operation to sense coupling capacitance formed as a result of a touch action when the common voltage scanning signal drives the sensing series 24. In other words, during the touch-sensing operation, the sensing series 22 may serve as a scanning electrode and the sensing series 24 as a sensing electrode, or the sensing series 24 may serve as a scanning electrode and the sensing series 22 as a sensing electrode. In this embodiment, the transparent electrodes 22a may be a plurality of stripe-shaped transparent electrodes that are substantially parallel to each other. If the sensing series 22 includes n (n is a positive integer) transparent electrodes 22a, the common voltage scanning signal may successively drive the transparent electrodes 22a from the first one to the n^{th} one or from the n^{th} one to the first one, depending on the refresh manner of a display frame. Each of the transparent electrodes 24a of the sensing series 24 receives a sensing signal, and each of the transparent electrodes 24a, detects according to the scanning sequence, voltage variations due to coupling capacitance that is formed as a result of a touch action, and detection results are transmitted to a signal processing unit such as an IC 26 to therefore sense touch positions. Each of the transparent electrodes 22 is electrically connected to common lines 32 of the array substrate 14 through a signal transfer pad 28. For example, the signal transfer pad 28 may include multiple conductive media 34 disposed between the color filter substrate 12 and the array substrate 14, and the conductive media 34 may be conductive spacers or silver paste. Further, the transparent electrodes 24a are connected to a plurality of conductive pads 38 on the array substrate 14 through flexible circuit boards 36 or other conductive media, and the conductive pads 38 and the IC chip 26 are connected with each other through wiring. Therefore, the transparent electrodes 24a may receive sensing signals from the IC chip 26. In one embodiment, signal control lines respectively for image display and touch-sensing are integrated in a signal processing unit such as the IC chip 26. The common voltage scanning signals provided by the IC chip 26 are transmitted to the sensing series 22 via the common lines 32 and the signal transfer pads 28 to successively drive the transparent electrodes 22a and meanwhile provide the common voltage for driving liquid crystal. The sensing signals provided by the IC chip 26 are transmitted to the sensing series 24 via the conductive pads 38 and the flexible circuit boards 36. The IC chip 26 also provides gate drive signals and pixel data signals to drive the liquid crystal layer 16 so as to effect image display. Moreover, self-capacitance sensing method and mutual-capacitance sensing method are both suitable for different embodiments of the invention. Though, as shown in FIG. 1, the transparent electrodes 22a of the sensing series 22 are parallel to each other and the transparent electrodes 24a of sensing series 24 are perpendicular to each other, this is not limited. In an alternate embodiment, the transparent electrodes 22a of the sensing series 22 are perpendicular to each other, and the transparent electrodes 24a of sensing series 24 are parallel to each other.

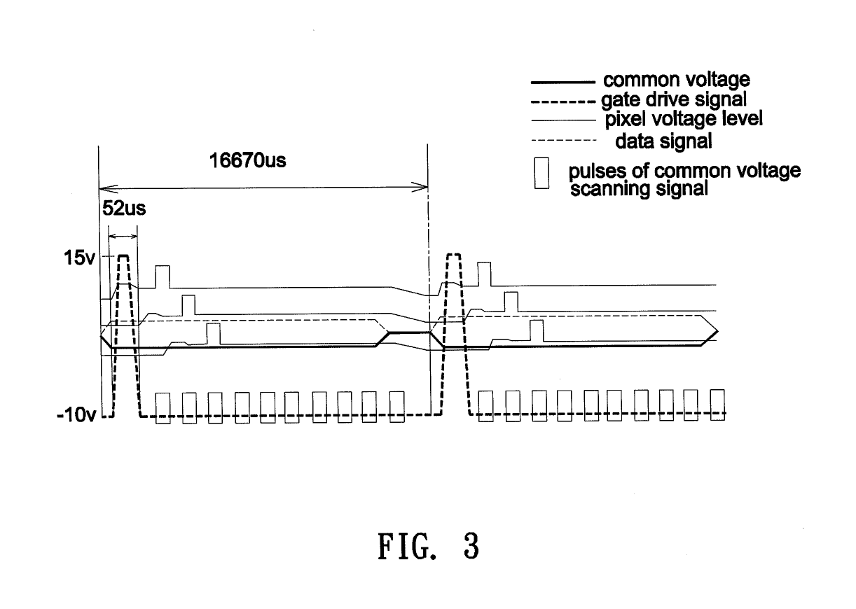

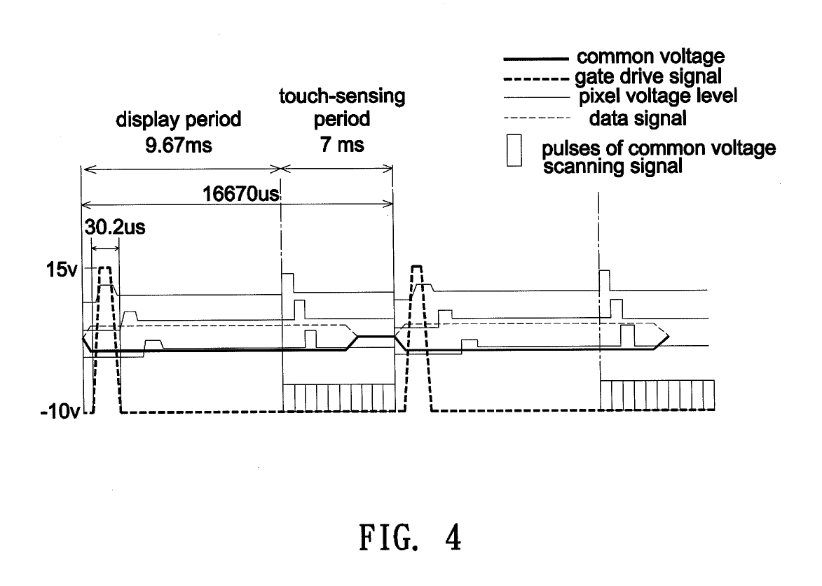

When a display frame is refreshed, the voltage level of the common electrode is not allowed to arbitrary change to conform to periodical polarity inversion schemes. Therefore, most part of a common voltage scanning signal keeps at a constant level, and each pulse of the common voltage scanning signal only maintains a short time sufficient to induce capacitance coupling (the duration of each pulse is much less than the liquid crystal response time). In addition, during the occurrence of pulses of the common voltage scanning signal, the gate drive signal is set to have a low level to prevent the common voltage scanning signal from affecting image display. In one embodiment, as shown in FIG. 3, pulses of the common voltage scanning signal are interpolated and evenly spaced in one display frame; that is, at least one driving line (transparent electrode 22a) of a touch-sensing structure is driven after a certain amount of gate lines are scanned. Alternatively, as show in FIG. 4, the frame time of a display frame may be divided into a display period and a touch-sensing period. After all gate lines are scanned to refresh a display frame, a trigger signal is generated to immediately drive all the driving lines (transparent electrodes 22a) of the touch-sensing structure. Finally, the priority control of signal output is returned to a display driver circuit after all the driving lines are driven.

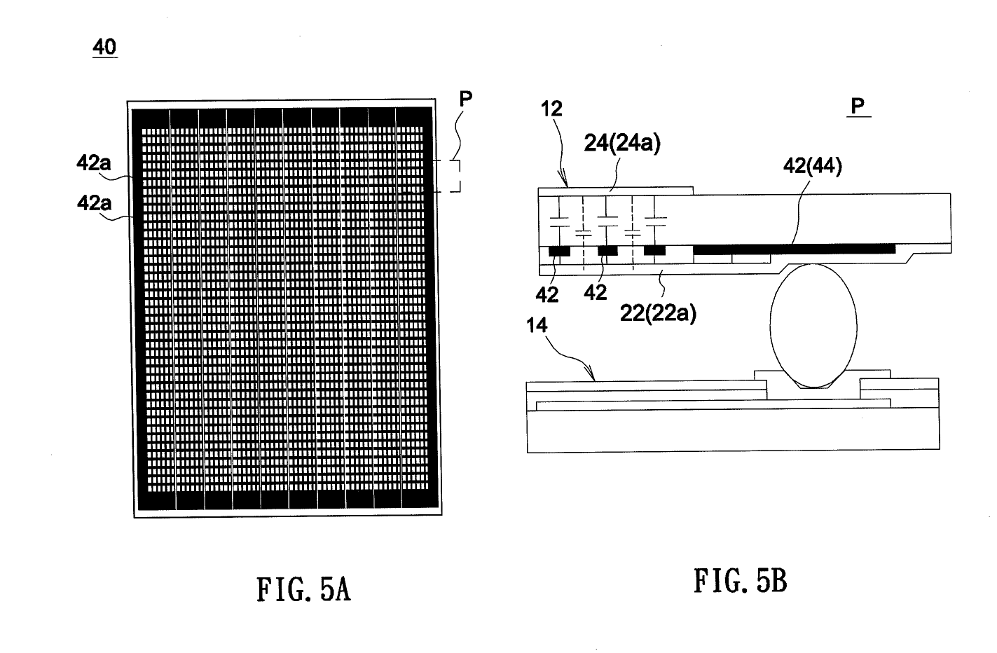

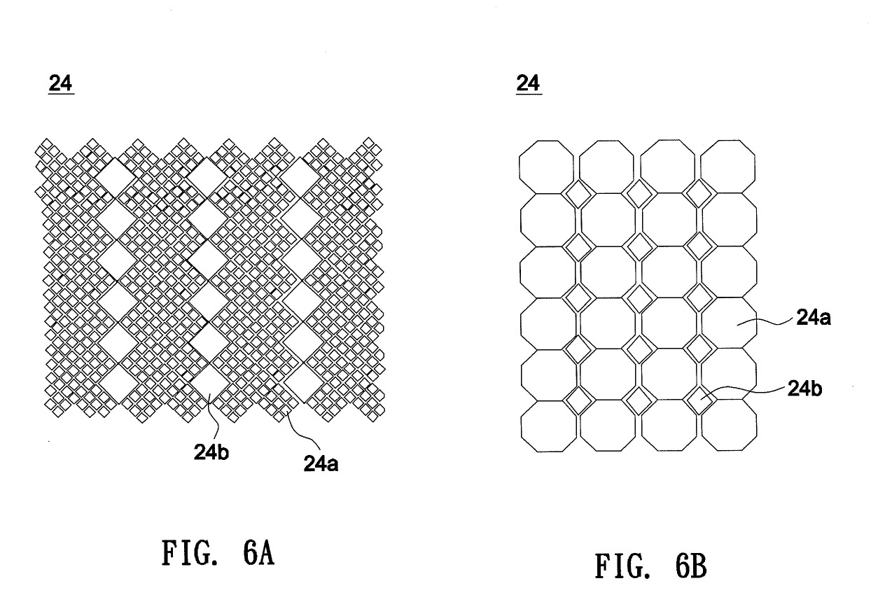

As shown in FIG. 2, two adjacent transparent electrodes 22a on the color filter substrate 12 are separated from each other to avoid short-circuit. In an alternate embodiment shown in FIG. 5A and FIG. 5B, a black matrix layer 42 of a touch-sensitive display device 40 includes a plurality of blocks 42a that are disconnected from each other and formed by conductive metal such as chromium. The transparent electrodes 22a may be connected to the conductive black matrix layer 42 to increase the amount of coupling capacitance. Besides, the black matrix layer 42 formed on a periphery of the color filter substrate 12 may serve as a decorative layer 44 to shield metal traces. The material of the decorative layer 44 may include, but is not limited to, at least one of ceramic, diamond-like carbon, colored ink, photo resist and resin. Further, the transparent electrodes 24a for receiving the sensing signal are not limited to be in the shape of multiple stripes parallel to each other shown in FIG. 2. For example, the transparent electrodes 24a may be in the shape of a diamond (FIG. 6A) or a polygon (FIG. 6B). Besides, auxiliary sensing electrodes 24b may fill the space formed between the transparent electrodes 24a to compensate for visual discrimination or increase the amount of coupling capacitance.

According to the above embodiments, since the sensing series 22 of the touch-sensing structure 20 also serves as a common electrode needed to drive the liquid crystal layer 16, the driving wiring of the touch-sensing structure and the reference voltage wiring of the display structure are integrated together to reduce signal interference and load, decrease the area of wiring layout to increase the aperture ratio, and reduce the size and weight of the entire device.

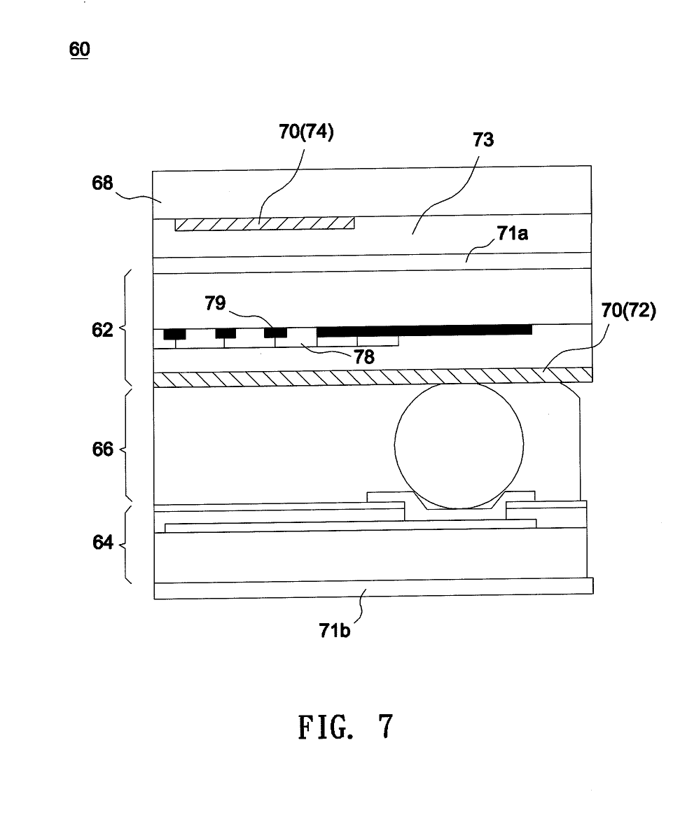

FIG. 7 shows a schematic diagram of a touch-sensitive display device according to another embodiment of the invention. As shown in FIG. 7, a touch-sensitive display device 60 includes a color filter substrate 62, an array substrate 64, a liquid crystal layer 66 disposed between the color filter substrate 62 and the array substrate 64, a cover glass 68 and a touch-sensing structure 70. Besides, a polarizer 71a is disposed on an outer side of the color filter substrate 62, and a polarizer 71b is disposed on an outer side of the array substrate 64. The cover glass 68 is adhered to one side of the color filter substrate 62 back to the array substrate 64 via an optical adhesive 73. The optical adhesive 73 may cover the entire surface or only the periphery of the surface. The touch-sensing structure 70 includes a sensing series 72 and a sensing series 74. In this embodiment, the sensing series 72 is formed on one side of the color filter substrate 62 facing the array substrate 64, and on that side a plurality of color filters 78 and a black matrix layer 79 are formed. The sensing series 74 is formed on one side of the cover glass 68 facing the color filter substrate 62. In this embodiment, the sensing series 72 serves as a common electrode needed to drive the liquid crystal layer 66. During the touch-sensing operation, the sensing series 72 receives a common voltage scanning signal, and the sensing series 74 receives a sensing signal to sense coupling capacitance formed as a result of a touch action when the common voltage scanning signal drives the sensing series 72. In an alternate embodiment, the sensing series 74 may receive a common voltage scanning signal, and the sensing series 72 may receive a sensing signal to sense coupling capacitance formed as a result of a touch action when the common voltage scanning signal drives the sensing series 74. The electrode structure of the touch-sensing structure 70 is similar to the embodiment shown in FIG. 2, thus not describing in detail here.

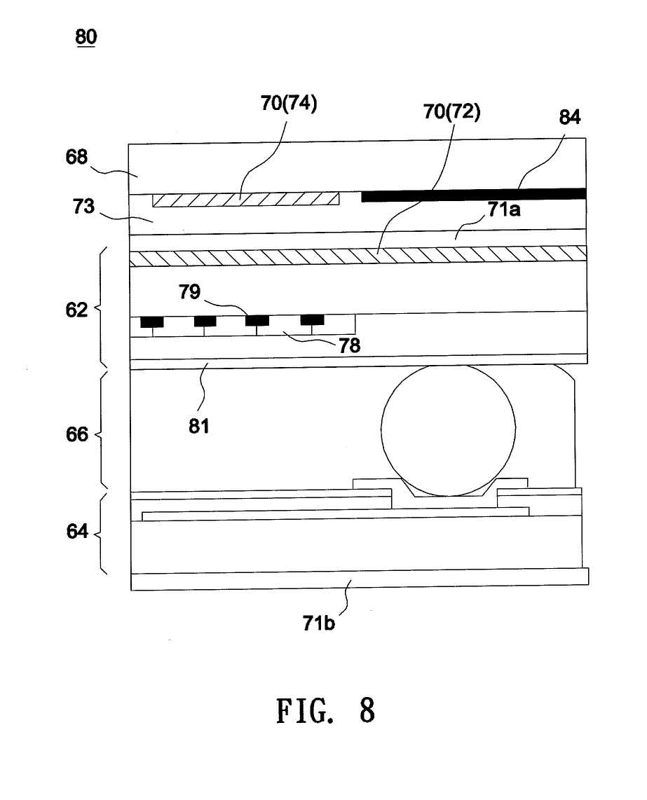

As shown in FIG. 8, according to another embodiment, the sensing series 72 of the touch-sensitive display device 80 is formed on one side of the color filter substrate 62 facing the cover glass 68, and the sensing series 74 is formed on one side of the cover glass 68 facing the color filter substrate 62. A common electrode 81 needed to drive the liquid crystal layer 66 is formed on one side of the color filter substrate 62 facing the array substrate 64. The sensing series 72 and the common electrode 81 receive the same common voltage scanning signal to perform scanning operations for image display and touch-sensing, respectively. Besides, as shown in FIG. 8, a decorative layer 84 is formed on a periphery of the cover glass 68 to shield metal traces. The material of the decorative layer 84 may include, but is not limited to, at least one of ceramic, diamond-like carbon, colored ink, photo resist and resin.

According to the above embodiments, a touch-sensitive display device is formed simply by combining a display panel and a cover glass that are respectively subject to a treatment of forming transparent electrodes (such as ITO). Therefore, the number of fabrication processes is reduced and the product yields are improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A touch-sensitive display device, comprising:
a color filter substrate;
an array substrate disposed opposite the color filter substrate and spaced apart from the color filter substrate;
a liquid crystal layer disposed between the color filter substrate and the array substrate; and
a touch-sensing structure disposed on the color filter substrate and comprising at least one first sensing series and at least one second sensing series overlapped with and spaced apart from the first sensing series, wherein, during a touch-sensing operation, the first sensing series receives a common voltage scanning signal and the second sensing series receives a sensing signal to sense coupling capacitance formed as a result of a touch action when the common voltage scanning signal drives the first sensing series.

2. The touch-sensitive display device as claimed in claim 1, wherein the first sensing series is disposed on one side of the color filter substrate facing the array substrate, and the second sensing series is disposed on one side of the color filter substrate back to the array substrate.

3. The touch-sensitive display device as claimed in claim 1, wherein the first sensing series is disposed on one side of the color filter substrate back to the array substrate, and the second sensing series is disposed on one side of the color filter substrate facing the array substrate.

4. The touch-sensitive display device as claimed in claim 1, wherein the first sensing series comprises n (n is a positive integer) first stripe electrodes substantially parallel to each other, and the common electrode scanning signal successively drives the first stripe electrodes.

5. The touch-sensitive display device as claimed in claim 4, wherein the second sensing series comprises a plurality of second stripe electrodes substantially parallel to each other, and the second stripe electrodes cross the first stripe electrodes.

6. The touch-sensitive display device as claimed in claim 1, wherein the first sensing series serves as a common electrode needed to drive the liquid crystal layer.

7. The touch-sensitive display device as claimed in claim 6, further comprising:
a plurality of common lines formed on the array substrate, wherein the first sensing series is connected with the common lines.

8. The touch-sensitive display device as claimed in claim 7, further comprising:
a plurality of conductive media disposed between the color filter substrate and the array substrate to connect the first sensing series with the common lines.

9. The touch-sensitive display device as claimed in claim 8, wherein each of the conductive media comprises a conductive spacer or silver paste.

10. The touch-sensitive display device as claimed in claim 6, further comprising:
a plurality of conductive pads formed on the array substrate; and
at least one flexible circuit board connected to the second sensing series and the conductive pads.

11. The touch-sensitive display device as claimed in claim 6, further comprising:
a conductive black matrix layer formed on the color filter substrate and connected to the first sensing series.

12. The touch-sensitive display device as claimed in claim 1, further comprising:
a decorative layer disposed on a periphery of the color filter substrate.

13. The touch-sensitive display device as claimed in claim 12, wherein the decorative layer comprises at least one of ceramic, diamond-like carbon, color ink, photo resist and resin.

14. A touch-sensitive display device, comprising:
a color filter substrate:
an array substrate disposed opposite the color filter substrate and spaced apart from the color filter substrate;
a liquid crystal layer disposed between the color filter substrate and the array substrate;
a cover glass disposed on one side of the color filter substrate back to the array substrate; and
a touch-sensing structure disposed on the color filter substrate and comprising a first sensing series and a second sensing series overlapped with and spaced apart from the first sensing series, wherein, during a touch-sensing operation, the first sensing series receives a common voltage scanning signal and the second sensing series receives a sensing signal to sense coupling capacitance formed as a result of a touch action when the common voltage scanning signal drives the first sensing series.

15. The touch-sensitive display device as claimed in claim 14, wherein the first sensing series is formed on the color filter substrate, and the second sensing series is formed on the cover glass.

16. The touch-sensitive display device as claimed in claim 14, wherein the first sensing series is formed on the cover glass, and the second sensing series is formed on the color filter substrate.

17. The touch-sensitive display device as claimed in claim 14, wherein the cover glass is adhered to one side of the color filter substrate back to the array substrate via an optical adhesive.

18. The touch-sensitive display device as claimed in claim 14, wherein the first sensing series is disposed on one side of the color filter substrate facing the cover glass, and the second sensing series is disposed on one side of the cover glass facing the color filter substrate.

19. The touch-sensitive display device as claimed in claim 14, wherein the first sensing series is formed on one side of the color filter substrate facing the array substrate and serves as a common electrode needed to drive the liquid crystal layer, and the second sensing series is formed on one side of the cover glass facing the color filter substrate.

20. The touch-sensitive display device as claimed in claim 14, wherein the first sensing series comprises n (n is a positive integer) first stripe electrodes substantially parallel to each other, and the common electrode scanning signal successively drives the first stripe electrodes.

21. The touch-sensitive display device as claimed in claim 20, wherein the second sensing series comprises a plurality of second stripe electrodes substantially parallel to each other, and the second stripe electrodes cross the first stripe electrodes.

22. The touch-sensitive display device as claimed in claim 14, further comprising:
a decorative layer disposed on a periphery of the color filter substrate.

23. The touch-sensitive display device as claimed in claim 22, wherein the decorative layer comprises at least one of ceramic, diamond-like carbon, color ink, photo resist and resin.

24. A touch-sensitive display device, comprising:
a first substrate:
a second substrate disposed opposite the first substrate and spaced apart from the first substrate;
a liquid crystal layer, disposed between the first substrate and the second substrate;
a touch-sensing structure disposed at least on the first substrate and comprising a plurality of driving electrodes and a plurality of sensing electrodes overlapped with and spaced apart from the driving electrodes; and
a signal processing unit disposed on the second substrate, wherein the signal processing unit outputs at least one gate drive signal, at least one pixel data signal and at least one common voltage scanning signal to drive the liquid crystal layer and effect image display, the signal processing unit outputs at least one sensing signal to sense coupling capacitance formed as a result of a touch action, and each of the sensing electrodes receives the sensing signal to sense the coupling capacitance when the common voltage scanning signal successively drives the driving electrodes.

25. The touch-sensitive display device as claimed in claim 24, further comprising:
a plurality of conductive media disposed between the first substrate and the second substrate, wherein the common voltage scanning signal is transmitted to the driving electrodes through the conductive media.

26. The touch-sensitive display device as claimed in claim 24, further comprising:
a plurality of conductive pads formed on the second substrate and connected to the signal processing unit; and
at least one flexible circuit board connected to the sensing electrodes and the conductive pads.

27. The touch-sensitive display device as claimed in claim 24, wherein the gate drive signal is in a low voltage level during the occurrence of pulses of the common voltage scanning signal.

28. The touch-sensitive display device as claimed in claim 24, wherein pulses of the common voltage scanning signal are interpolated and evenly spaced in one display frame.

29. The touch-sensitive display device as claimed in claim 24, wherein the frame time of a display frame is divided into a display period and a touch-sensing period, and the common voltage scanning signal drives the driving electrodes only in the touch-sensing period.

30. The touch-sensitive display device as claimed in claim 24, further comprising:
a cover glass adhered to one side of the first substrate back to the second substrate, wherein the touch-sensing structure is disposed on the first substrate and the cover glass.
